(19) United States
(12) Patent Application Publication
(10) Pub. No.: US 2001/0029489 A1
(43) Pub. Date: Oct. 11, 2001

(54) Adaptable secure funds source

(76) Inventors: George Brookner, Norwalk, CT (US); Rana Dutta, Shelton, CT (US); Carl Oppedahl, Dillon, CO (US)

Correspondence Address: PERMAN & GREEN, 425 POST ROAD, FAIRFIELD, CT, 06430, US

(21) Appl. No.: 09/785,654

(22) Filed: Feb. 16, 2001

Related U.S. Application Data
(60) Provisional application No. 60/182,971, filed on Feb. 16, 2000.

(51) Int. Cl. G06F 17/60; H04K 1/00; H04L 9/00; G06F 17/00; G07B 17/02

(52) U.S. Cl. 705/41; 705/60; 705/401; 705/65; 235/379

(57) ABSTRACT

An entity for securely storing a value indicative of funds available for use which comprises a first storage for storing the value; an externally readable identifier within the entity for providing a unique identification of the entity; a second storage in the entity for storing information assigning the entity to operate in an application; and communications for changing the information so as to assign the entity to a new application. A method for allocating use of such entity including a) relating the externally readable identifier to an application; b) configuring the entity to operate in the application; and reallocating the entity by repeating steps a) and b) for a different application. An adapter for use with the entity for communicating with an external system or for recharging the entity with funds from a location other than the one where it is used.

This application claims priority from provisional patent application Ser. No. 60/182,971 filed on Feb. 16, 2000, which application is incorporated herein by reference.

### BACKGROUND OF THE INVENTION

1. Field of the Invention

The present invention relates to secure sources of funds.

More particularly, it relates to devices in of the nature of postal security devices (PSD's).

2. Prior Art

The PSD is a device for electronically securely storing the value of funds that will eventually be expended, and in particular may be exchanged for the printing of postal indicia to allow mail pieces to be processed by the post office, or in a more general case by other carriers. In general PSD's are designed for use in several environments. Those environments include operation within a closed system; operation in an open system, and operation at a data center.

The PSD within a closed system provides all the functionality and security required by United States Postal Service Information Based indicia Program (IBIP). The use of a ZIP code is not required. In a closed system, the printing function is integral to the device in which the PSD is located. The PSD within an open system performs as does that in a closed system except that this application requires the user/operator to input the recipient's ZIP code. In general is such open systems, it is also necessary to insure that addresses are “cleansed” so that they are in an acceptable format. In an open system, the printing function is performed externally to the device in which the PSD is located.

The applications in which the PSD(s) are located in a remote Data Center provide for customer installations where the PSD is “virtual” to the customer. That is, the PSD is physically located at a secure data center remote from the customer sites. These “virtual” PSDs are able to service multiple customers. When one, or a bank of PSDs cannot handle additional volume, more PSDs are added to the data center PSD bank.

The above applications of PSD usage require the retirement or scrapping or remanufacturing of PSDs should it not be possible to exchange one PSD application with another. For example, should the market be such that one of the above environments is losing its attractiveness to customers, the vendor, which is required by United States Postal Service regulations to own the PSDS, could be left with a useless inventory of PSDs that are specific to one of the noted environments. Further, should a customer of one of the environments choose to switch to another environment, the new environment necessitates a new PSD since it is generally not possible to move that customer's PSD to the new environment. In the case of the “virtual PSD”, the customer-specific data of that physical PSD at the customer site must be transferred to that specific customer's new account in the remote data center's PSD bank.

### SUMMARY OF THE INVENTION

It is an object of this invention to identify each PSD at its time of manufacture as unique from any other PSD ever manufactured. To accomplish this, each PSD internal circuit board clocking device is specially identified with a character string that can be accessed by the remote data center. Thereafter, the PSD may be remotely related to a customer, function-set, environment, etc. by relating the character string to the customer, function-set, environment, etc. Further, an external identification may be applied to the PSD housing (e.g. serial number) to outwardly allow human identification of the PSD. The serial number may be assigned by the remote data center or internally generated by the PSD (and communicated to the remote data center). The customer label printer may print the serial number, or the serial number may be supplied from the remote data center. The serial number would, optimally, be bar-coded as well as human readable. Thereafter, the PSD is identifiable remotely via communication with the remote data center, visibly by reading the serial number, or electronically, by scanning the bar-code.

Thus, in accordance with the invention an entity for securely storing a value indicative of funds available for use, comprises a first storage for storing the value; an externally readable identifier within the entity for providing a unique identification of the entity; a second storage in the entity for storing information assigning the entity to operate in an application; and communication means for changing said information so as to assign the entity to a new application. The identifier may digital data, in the form of a character string stored on said circuitry in the entity.

The entity may be used in combination with an adapter for connecting to the entity, wherein the adapter comprises an electrical connector for electrically connecting to the entity, and an interface for supporting communication between the entity and an external system, so that the entity can be identified by the external system by reading the identifier.

The entity may be configured as a virtual entity on a computer and/or may be useful as a postal funds security device. It may be used in a closed or in an open postal system and embodied in the form of an apparatus, further comprising a human readable identifier corresponding to the internally stored identifier, the human readable identifier being displayed externally on the apparatus. A bar code or serial number may be displayed.

The invention is also directed to a method for allocating use of an entity for securely storing a value indicative of funds available for use; the entity having an externally readable identifier within the entity for providing a unique identification of the entity, the method comprising: a) relating the externally readable identifier to an application; b) configuring the entity to operate in the application; and reallocating the entity by repeating steps a) and b) for a different application.

The invention is further directed to an adapter for connecting to a device for securely storing a value indicative of funds available for use, the device having at least one register for storing the value; and an externally readable identifier within the device for providing a unique identification of the device. The adapter comprises an electrical connector for electrically connecting to said device, and an interface for supporting communication between the device and an external system, so that the device can be identified by the external system by reading the identifier.

In addition the invention encompasses a method for adding value to a device for the secure storage of value corresponding to funds to be expended, the device being located in a first location. The method comprises moving the device to a second location where communications with a remote system which acts as a source of the value of funds can be established; placing the device in an adapter having an interface suitable for facilitating communication between the device and the remote location; and authorizing a value transfer to the device. The method may further comprise authorizing operation of the device when the device has been moved to the second location.

### BRIEF DESCRIPTION OF THE DRAWINGS

The foregoing aspects and other features of the present invention are explained in the following description, taken in connection with the accompanying drawings, wherein:

FIG. 1 is a top plan view of a PSD which may be used in the present invention.

FIG. 1A is conceptual diagram of the PSD of FIG. 1.

FIG. 2 is a partially cut away perspective view of a first embodiment of an adapter in accordance with the invention.

FIG. 3 is a top plan view of a second embodiment of an adapter for the PSD of FIG. 1, in accordance with the invention.

FIG. 4 is a bottom plan view of the adapter of FIG. 3.

FIG. 5 is a perspective view of the adapter of FIG. 3.

FIG. 6 is a plan view illustrating the PSD FIG. 1 inserted into the lower portion of the housing of the adapter of FIG. 3.

### DETAILED DESCRIPTION OF THE PREFERRED EMBODIMENTS

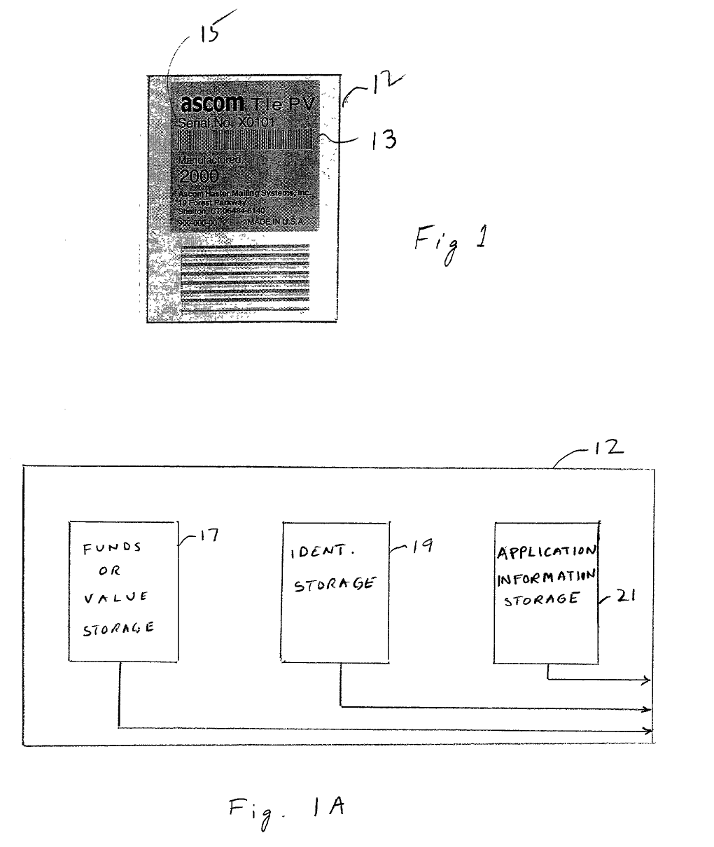

Referring to FIG. 1, there is shown a plan view of a PSD 12 used in the present invention. Although the present invention will be described with reference to the embodiments shown in the drawings, it should be understood that the present invention can be embodied in many alternate forms of embodiments. For example, hardware components may be implemented in software.

PSD 12 may be any of various kinds well known in the art such as a Postlink Model manufactured by Ascom Hasler Mailing Systems of Shelton, Connecticut. As is well known in the art, PSD has an ascending register, a descending register, and interface circuitry for electronically transferring the value of funds into the descending register, which funds are decremented as postage is printed in a postage printing system that uses PSD 12 as a source of funds. PSD 12 is also generally equipped with encryption and decryption technology to allow only authorized access to data and funds contained therein. The system used for these purposes may, in an exemplary embodiment, be the system described in U.S. Pat. No. 6,009,417, issued Dec. 28, 1999, hereby incorporated herein by reference. The PSD may contain a system clock updated according to the technique described in U.S. Pat. No. 6,078,910, issued Jun. 20, 2000, which patent is hereby incorporated herein by reference. Key pairs used therein may be updated as described in U.S. Pat. No. 6,041,317, issued Mar. 21, 2000, incorporated herein by reference.

It will be understood that while PSD 12 may be a hardware device, it is also possible for it to be a virtual entity or device. Thus, it may be effected by a software program running on a centralized computer, thus providing secure access to funds by one or more remote users, each using a postal device of the open or closed kind, as more fully described below. Thus, it is possible to think of a PSD as an entity, either in hardware or software, which performs the function described above.

In either case, whether in hardware form, or in software form, in accordance with the invention, every PSD 12 has unique digital identification data, such as a character string, which uniquely identifies that PSD and no other. This identification data is readable by an external system that interfaces with the PSD 12 by means of an electrical connector. When in hardware form, PSD 12 may also include externally readable indicia corresponding to this digital identification data, such as a bar code 13 and a serial number 15.

FIG. 1A illustrates a funds or value storage 17, an identifier storage 19, and an application information storage 21, within a PSD 12 in accordance with the present invention.

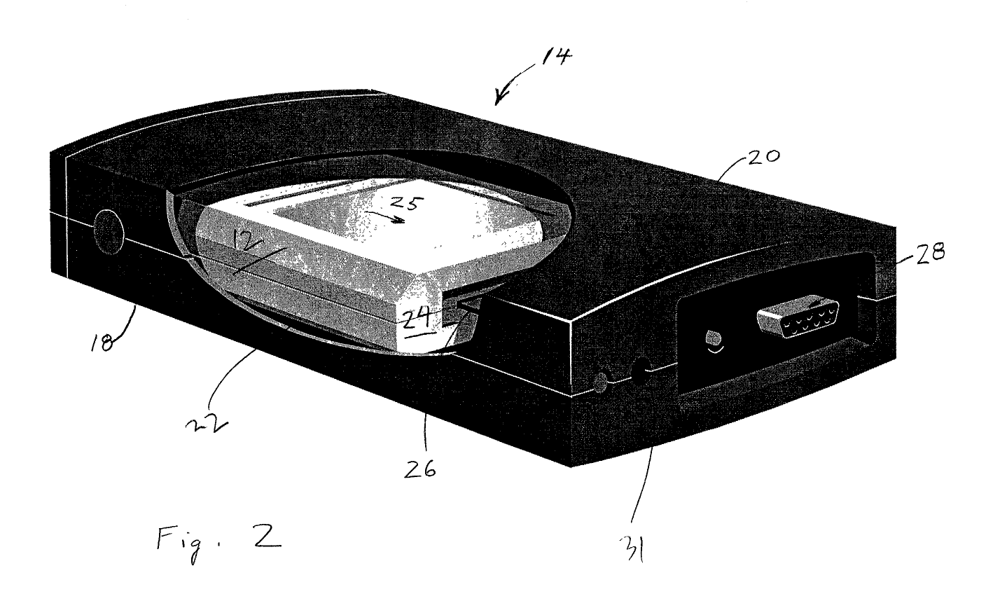

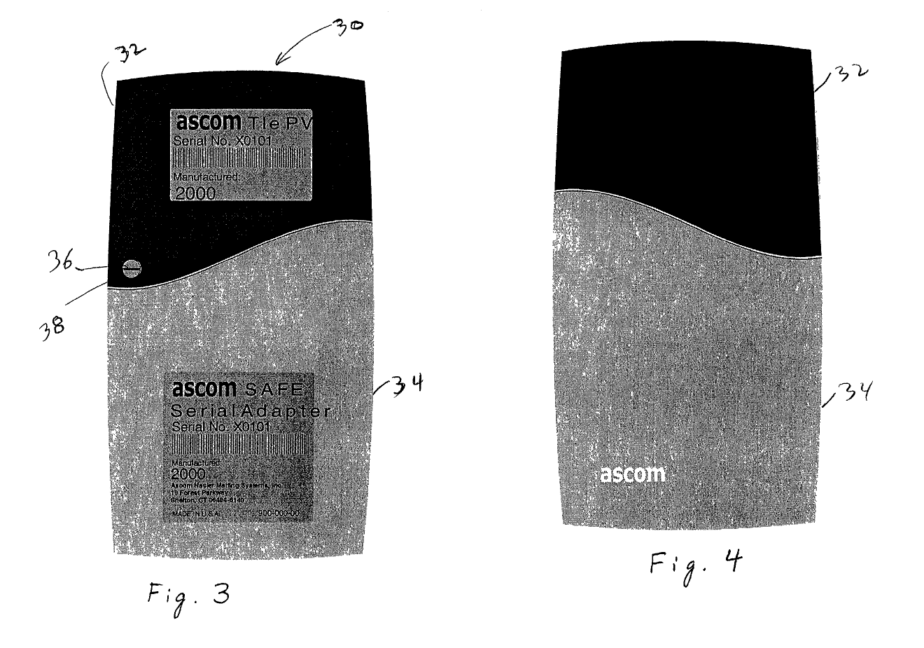

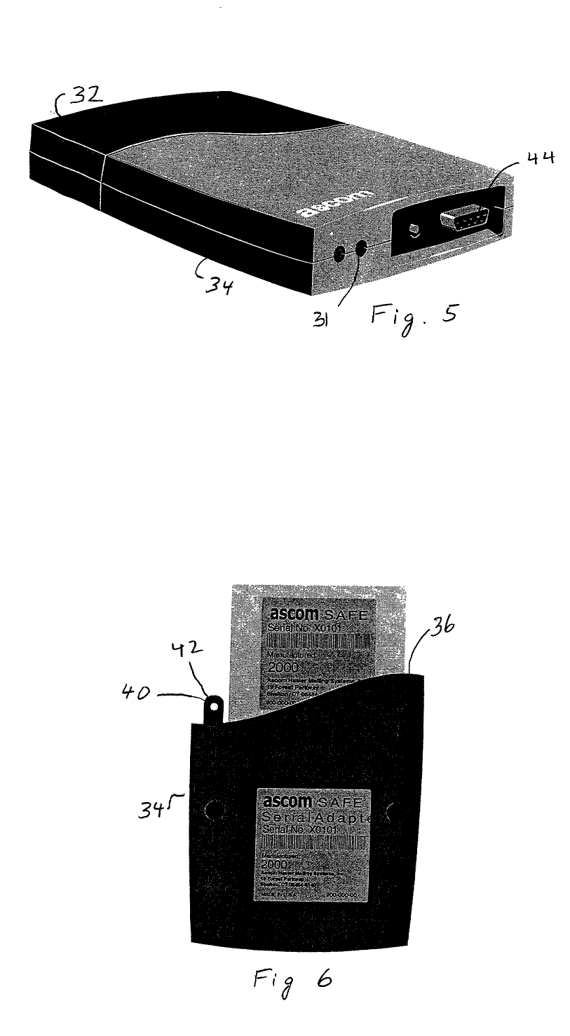

FIG. 2 illustrates a first embodiment of an adapter 14 in accordance with the invention for receiving a PSD 12. FIG. 3 through FIG. 6 illustrate a second embodiment of an adapter 16 in accordance with the invention for receiving a PSD 12. While the design details may be different, the essential principles of operation are the same.

In FIG. 2, adapter 14 is formed of a top housing portion 18 and a bottom housing portion 20, the walls of which together define an opening 22 for receiving PSD 12. Housing portions 18 and 20 may be formed from, for example, suitable polymers, and assembled together as shown in FIG. 2, or dissembled to receive PSD 12. opening 22 is sized, shaped and positioned so that PSD 12 can be placed in bottom portion 18 when the portions 18 and 20 are disassembled, and than pushed by hand in the direction indicated by arrow 24, so that a connector associated with its lower surface 24 receives a circuit board 26 of adapter 14. The top and bottom portions may then be assembled with PSD 12 disposed therein as shown. Circuit board 26 has electrical conductors (not shown) on its surfaces, which are used to make electrical connections to PSD 12. Circuit board 26 also has appropriate electrical devices (also not shown) for providing an electrical interface to an external system by way of a an electrical connector 28, such as a D9 connector used as a serial interface connector in most small computers. It will be understood that this is merely an example, and that many different interfaces and appropriate electrical connectors or other types of connections may be used. For example, various protocols such as RS-232; IEEE 488; USB; TCP/IP; SCSI; infrared; optical; RF; net appliance protocols and personal computer bus protocols may be used. The latter may be of particular interest for direct interface to a bus in a personal computer.

Circuit board 26 may be powered in any one of several ways. Preferably, an opening 31 is provided for receiving a jack associated with an AC adapter of a type well known in the art, which is plugged into a standard wall power outlet and converts the power provided by the mains to a DC voltage suitable for powering circuit board 26. Alternatively, a battery (not shown) may be provided in adapter 14. This is generally less preferable because the battery would need to be replaced or recharged and would add weight and size. Yet another alternative, especially when a D9 cable is used to connect to a personal computer, is to borrow power from the personal computer.

The adapter 30 of FIG. 3 through FIG. 6 is formed of an upper housing portion 32 and a lower housing portion 34, the walls of which define a cavity 36 into which a PSD 12 may be inserted, when portions 32 and 34 are disassembled from one another. When assembled, portions 32 and 34 are held together by virtue of the action of a screw 36 extending through an opening 38 in upper housing portion 32, which is threaded into a hole 40 on a lug 42. Lug 42 may be an integral part of lower housing portion 34, or may be attached thereto by any one of several conventional means. A circuit board (not shown) similar to circuit board 26 of FIG. 2, is provided in adapter 30 to electrically interconnect with PSD 12 and to provide an interface, as discussed above. A connector 44 (FIG. 5) allows attachment of an appropriate cable (not shown) for communication with an external system as discussed above with respect to FIG. 2.

As stated above, the changing of the environment in which a PSD is used requires its contacting a remote data center, by Internet or modem, whereby the required transactions are recorded and stored, customer account files are updated, authority notification occurs and the PSD (or account data, in the case of the “virtual” PSD) is appropriately identified. The changes, wherein the PSD contacts the remote data center may occur through the PSDs host device (closed system meter, open system PC) In accordance with the invention, once the PSD is moved to its new installation environment, the remote data center in concert with secure key exchange protocols of Public Key Infrastructure (PKI) configures the PSD accordingly. This is done by changing or modifying the information in the application information storage 21 (FIG. 1A). As an example of a mechanism to assure that the PSD is not fraudulently absconded, a special password may be given to the customer via facsimile, priority mail, or telephone. This password is then entered on the new environment equipment by the customer, thus identifying the customer to the remote data center. Other secure identification non-repudiation mechanisms also include Public Key message exchanges, which may use, for example, PGP.

Further, it is possible to take a PSD relegated to a postage payment application and apply it to a new environment that is a multi-carrier payment system. Still further, the PSD may be applied to a general purpose environment that requires a secure authenticating funds engine.

Yet another use for the adapters is the situation in which the customer does not wish to change environments, but the PSD is located in an apparatus, such as a large mailing machine, in an area not serviced by a telephone or Internet connection. The PSD may be removed from the mailing machine and placed in an adapter in accordance with the invention. The adapter may then be moved to a location having, for example, a personal computer with appropriate software loaded thereon. The adapter is connected to the computer with an appropriate cable by way of the D9 or other connector. A connection is established with the remote data center, and with appropriate authorization, additional funds are transferred into the descending register of the PSD. After the connection is terminated, the PSD is removed from the adapter and returned to the mailing system where the additional funds are used when printing postage on the mail pieces.

It will be understood that in this advantageous manner, a number of PSDs, each normally located in different locations, may be recharged at a single location, using a single personal computer. Alternatively, as described above, when this approach is used, the PSD may be reconfigured for use in a different location, or in a different application, or both.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. An entity for securely storing a value indicative of funds available for use, comprising;
a first storage for storing said value;
an externally readable identifier within said entity for providing a unique identification of said entity;
a second storage in said entity for storing information assigning said entity to operate in an application; and
communications for changing said information so as to assign said entity to a new application.

2. The entity of claim 1, wherein said identifier is digital data.

3. The entity of claim 1 wherein said identifier is a character string.

4. The entity of claim 2, further comprising circuitry, wherein said digital data is stored on said circuitry.

5. The entity of claim 1, in combination with an adapter for connecting to said entity, said adapter comprising:
an electrical connector for electrically connecting to said entity, and
an interface for supporting communication between said entity and an external system, so that said entity can be identified by said external system by reading said identifier.

6. The entity of claim 5, wherein said interface supports communication with at least one protocol selected from the group consisting of RS-232; IEEE 488; USB; TCP/IP; SCSI; Infrared; RF; net appliance protocol; and personal computer bus protocols.

7. The entity of claim 1, configured as a virtual entity on a computer.

8. The entity of claim 1, configured so as to be useful as a postal funds security device.

9. The entity of claim 8, configured to be used in a closed postal system device, wherein the printing function is integral to the device.

10. The entity of claim 8, configured to be used in an open postal system device, wherein the printing function is external to the device.

11. The entity of claim 1, embodied in the form of an apparatus, further comprising a human readable identifier corresponding to said internally stored identifier, said human readable identifier being displayed externally on said apparatus.

12. The entity of claim 1, embodied in the form of an apparatus, further comprising externally visible indicia on said apparatus, said indicia corresponding to said internally stored identifier.

13. The entity of claim 12, wherein said externally visible indicia comprises at least one of a bar code and a serial number.

14. A method for allocating use of an entity for securely storing a value indicative of funds available for use; said entity having an externally readable identifier within said entity for providing a unique identification of said entity, said method comprising;
a) relating said externally readable identifier to an application;
b) configuring the entity to operate in said application; and
c) reallocating said entity by repeating steps a) and b) for a different application.

15. A method for allocating use of an entity for securely storing a value indicative of funds available for use; said entity having a storage for storing said value; and an externally readable identifier within said entity for providing a unique identification of said entity, said method comprising:
a) relating said externally readable identifier to an application; and
b) configuring the entity to operate in said application.

16. The method of claim 15, wherein said identifier is digital data.

17. The method of claim 15, wherein said identifier is a character string.

18. The method of claim 15, wherein said identifier is digital data stored in circuitry in said entity.

19. The method of claim 15, wherein said entity is embodied in a device, further comprising establishing communication between said device and a system external to said device.

20. The method of claim 19, further comprising identifying said device by reading said identifier.

21. The method of claim 20, further comprising:
connecting said device to an adapter, said adapter comprising an electrical connector for electrically connecting to said device, and an interface for supporting communication between said device and an external system, and
identifying said device with said external system by said external system reading said identifier.

22. The method of claim 21, wherein communication is established with at least one protocol selected from the group consisting of RS-232; IEEE 488; USB; TCP/IP; SCSI; infrared; optical: RF; net appliance protocol; and personal computer bus protocols.

23. The method of claim 15, wherein said entity is configured as a virtual entity on a computer.

24. The method of claim 15, wherein said entity is configured so as to be useful as a postal funds security device.

25. The method of claim 24, wherein said entity is configured to be used in a closed postal system.

26. The method of claim 24, wherein said device is configured to be used in an open postal system.

27. The method of claim 15, wherein said entity is embodied in the form of a device, further comprising placing, externally on said device, a human readable identifier corresponding to said internally stored identifier.

28. The method of claim 15, wherein said entity is embodied in the form of a device, further comprising placing externally visible indicia on said device, said indicia corresponding to said internally stored identifier.

29. The method of claim 28, wherein said externally visible indicia comprises at least one of a bar code and a serial number.

30. The method of claim 15, further comprising reallocating said entity by repeating steps a) and b) for a different application.

31. The method of claim 30, further comprising placing said entity in a different environment before accomplishing said reallocation.

32. The method of claim 31, further comprising authorizing said reallocation using a secure authorization step.

33. The method of claim 32, wherein said step comprises at least one of using encryption and using a password to authenticate said authorization step.

34. An adapter for connecting to a device for securely storing a value indicative of funds available for use, said device having at least one register for storing said value; and an externally readable identifier within said device for providing a unique identification of said device, said adapter comprising:
an electrical connector for electrically connecting to said device, and
an interface for supporting communication between said device and an external system, so that said device can be identified by said external system by reading said identifier.

35. The adapter of claim 34, wherein said interface supports additional communication between said external system and said device so as to reconfigure said device for a new application of said device.

36. The adapter of claim 34, wherein said interface supports additional communication between said external system and said device so as to enable adding value to said register.

37. A method for adding value to a device for the secure storage of value corresponding to funds to be expended, said device being located in a first location, said method comprising:
moving said device to a second location where communications with a remote system which acts as a source of said value of funds can be established;
placing said device in an adapter having an interface suitable for facilitating communication between said device and said remote location; and
authorizing a value transfer to said device.

38. The method of claim 37, further comprising authorizing operation of said device when said device has been moved to said second location.
